(19) United States
(12) Patent Application Publication
(10) Pub. No.: US 2026/0331853 A1
(43) Pub. Date: Oct. 22, 2026

(54) CRIMPING PLIERS

(71) Applicant: Wenzhi LUO, Shaoguan (CN)

(72) Inventors: Wenzhi LUO, Shaoguan (CN); Qifei ZHANG, Shangrao (CN)

(21) Appl. No.: 19/695,059

(22) Filed: Jun. 2, 2026

(30) Foreign Application Priority Data
May 27, 2025 (CN) 202521049492.3

(51) Int. Cl. H01R 43/042; B21D 39/04

(52) U.S. Cl. CPC H01R 43/042; B21D 39/048

(57) ABSTRACT

A crimping pliers, including a fixed handle, an active handle, and a jaw, the crimping pliers further includes an adjusting component for adjusting an opening size of the jaw. The adjusting component including an eccentric shaft, which passes through both the active handle and the jaw. A knob is fixedly connected to a first end of the eccentric shaft. A limiting component is mounted at a second end of the eccentric shaft. A first reset component, positioned between the knob and the active handle. When the first reset component is in a first compressed state, the limiting component is fixed relative to the active handle; and when the first reset component is compressed by the knob and in a second compressed state, the limiting component is separated from the active handle, allowing a rotation of the eccentric shaft to drive the jaw to rotate.

### CROSS REFERENCE TO RELATED APPLICATIONS

This application claims foreign priority of Chinese Patent Application No. 202521049492.3, filed on May 27, 2025 in the China National Intellectual Property Administration, the disclosures of all of which are hereby incorporated by reference.

### TECHNICAL FIELD

The present disclosure relates to the technical field of crimping tool, in particular to a crimping pliers.

### BACKGROUND

Crimping tools are used to press wires and terminals together. Due to the variety of wire types and models, corresponding crimping pliers are required, which often leads to issues such as cumbersome carrying and tool loss. Currently, torque adjustment mechanisms are commonly used to adjust the opening size of the jaw to accommodate different wiring requirements. Existing torque adjustment mechanisms use screws that require additional tools to unscrew before adjustment can be made. After the adjustment is completed, tools are also needed for re-tightening, leading to cumbersome adjustment processes.

### SUMMARY

The present disclosure provides a crimping pliers that facilitates improved ease of adjustment.

To realize the above objective, the present disclosure provides a XXXX, including: a fixed handle, an active handle, and a jaw, the crimping pliers further includes an adjusting component for adjusting an opening size of the jaw, the adjusting component including: an eccentric shaft, which passes through both the active handle and the jaw, the eccentric shaft is configured to drive the jaw to rotate relative to the fixed handle; a knob, fixedly connected to a first end of the eccentric shaft; a limiting component, mounted at a second end of the eccentric shaft; and a first reset component, positioned between the knob and the active handle; when the first reset component is in a first compressed state, the limiting component is fixed relative to the active handle; and when the first reset component is compressed by the knob and in a second compressed state, the limiting component is separated from the active handle, allowing a rotation of the eccentric shaft to drive the jaw to rotate.

Furthermore, the limiting component includes: a limiting seat, fixed to the second end; a limiting protrusion, provided on the limiting seat or a surface of the active handle; the limiting seat or the active handle is defined with a limiting hole for the limiting protrusion to fit into, when the first reset component is in the first compressed state, the limiting protrusion fits into the limiting hole.

Furthermore, the limiting protrusion is provided with at least two protrusions along a rotation axis of the eccentric shaft, and the limiting hole is provided with at least two limiting holes, one-to-one corresponding to the at least two limiting protrusions.

Furthermore, the first reset component is a spring, with both ends of the spring abutting against the knob and the active handle; when the spring is in the first compressed state, a gap is formed between the knob and the active handle.

Furthermore, a side surface of the knob is provided with an anti-slip pattern.

Furthermore, the jaw is defined with a mounting hole adjacent to the active handle, and the adjusting component further includes an eccentric wheel fixed in the mounting hole, the eccentric wheel is defined with a connection hole with a flattened position, through which the eccentric shaft fits.

Furthermore, the jaw includes an adjusting body, jaw teeth, and a third reset component; the adjusting body is passed through by the eccentric shaft, an end of the adjusting body away from the eccentric shaft is placed inside the fixed handle and defined with an accommodating through hole, an inner surface of the accommodating through hole is defined with multiple slots arranged in a ring; each of the jaw tooth has one end inserted into one of the multiple slots; each of the jaw teeth include a first surface and a second surface; a first plane is provided on the first surface away from multiple slots, and the first plane is inclined toward the second surface; the second surface includes a second plane, a third plane, and a fourth plane arranged in sequence; the third plane and the second plane and the fourth plane are obtuse angles, the obtuse angles are opposite to the first plane; and the fourth plane is adjacent to the first plane; when adjusting the opening size of the jaw, the fourth plane slides along the first plane of an adjacent jaw tooth of the jaw teeth.

Furthermore, the crimping pliers further include multiple first connecting shafts, each of the multiple first connecting shafts passing through one jaw tooth of the jaw teeth along a normal direction of the accommodating through hole and installed inside the fixed handle.

The present disclosure further provides a crimping pliers, the crimping pliers include a fixed handle, an active handle, a jaw, an adjusting component, and a releasing component, the adjusting component is configured to adjust an opening size of the jaw, the releasing component including: a driving component, which includes a third end and a fourth end; the third end is rotatably connected inside the fixed handle, the fourth end is rotatably connected inside the active handle, the fourth end is provides multiple teeth grooves, the multiple teeth grooves are arranged continuously; an unlocking lever, which includes a fifth end and a sixth end, the fifth end is rotatably connected inside the active handle, the sixth end is exposed on the outside of the active handle, the fifth end is provided with a catch tooth for engagement with the teeth grooves; a second reset component, one end of the second reset component is connected to the active handle and another end of the second reset component is connected to the fifth end; when the active handle and the fixed handle are pressed to a final position, the second reset component is configured to reset the unlocking lever.

Furthermore, the unlocking lever is inclined upwards towards a direction away from the fixed handle; or the unlocking lever is set to incline downwards in the direction away from the fixed handle.

Furthermore, an inside of the active handle is fixedly connected with a positioning rod, and the driving component is provided with a positioning slide groove for the positioning rod to slide, a center axis of the positioning slide groove is coincided with a rotation axis of the driving component on the active handle.

Furthermore, a side of the third end is round, and a connecting seat is provided inside the fixed handle, a limiting groove is provided on the connecting seat, the limiting groove is configured for partially embedding the third end.

Furthermore, the crimping pliers includes a second connecting shaft, a third connecting shaft, and a fourth connecting shaft, which are all installed inside the active handle; the second connecting shaft passes through the fourth end, the third connecting shaft passes through the unlocking lever, the unlocking lever is configured to rotate around the third connecting shaft; and the fourth connecting shaft passes through the second reset component at an end away from the unlocking lever.

Furthermore, the second reset component is a tension spring, and the fourth connecting shaft passes through the second reset component at an end away from the unlocking lever, causing the tension spring to rotate and connect to the active handle, and another end of the tension spring is connected to the fifth end; when the active handle and the fixed handle are pressed to the final position, the tension spring is configured to reset the unlocking lever.

The object of the present disclosure is to provide a crimping pliers that facilitates improved ease of adjustment. In the present disclosure, through the cooperation of an eccentric shaft, a knob, a limiting component, a first reset component, and the jaw, the limiting component can be separated from the active handle simply by pressing the knob. This allows the knob to be rotated, driving the eccentric shaft to rotate, thereby adjusting the opening size of the jaw without the need for additional tools, thereby improving the ease of adjustment of the crimping pliers.

The following is a more detailed description of the present disclosure in conjunction with the accompanying drawings and specific embodiments.

### BRIEF DESCRIPTION OF THE DRAWINGS

FIG. 1 is a schematic structural diagram of a crimping pliers according to an embodiment of the present disclosure.

FIG. 2 is a first exploded diagram of a partial of the crimping pliers according to an embodiment of the present disclosure.

FIG. 3 is a first schematic structural diagram of a partial of the crimping pliers according to an embodiment of the present disclosure.

FIG. 4 is a second exploded diagram of a partial of the crimping pliers according to an embodiment of the present disclosure.

FIG. 5 is a third exploded diagram of a partial of the crimping pliers according to an embodiment of the present disclosure.

FIG. 6 is an enlarged view of area A in FIG. 4.

FIG. 7 is a second schematic structural diagram of a partial of the crimping pliers according to an embodiment of the present disclosure.

FIG. 8 is a third schematic structural diagram of a partial of the crimping pliers according to an embodiment of the present disclosure.

FIG. 9 is a schematic structural diagram of the crimping pliers showing the catch teeth and the grooves in an engagement state.

FIG. 10 is a schematic structural diagram of the crimping pliers in FIG. 9, with anti slip covers removed.

### DESCRIPTION OF THE REFERENCE NUMERAL

100 crimping pliers, 10 fixed handle, 101 connecting seat, 102 limiting groove, 20 active handle, 201 limiting hole, 30 jaw, 31 adjusting body, 310 mounting hole, 311 accommodating through hole, 3110 slot, 32 jaw tooth, 321 first surface, 3211 first plane, 3212 concave surface, 3213 convex surface, 3221 second plane, 3222 third plane, 3223 fourth plane, 33 third reset component, 34 first connecting shaft, 40 adjusting component, 41 eccentric shaft, 411 first end, 412 second end, 42 knob, 421 anti-slip pattern, 43 limiting component, 431 first connecting portion, 432 limiting base, 430 limiting protrusion, 44 first reset component, 45 eccentric wheel, 450 connection hole, 46 second connecting portion, 47 protective cap, 5 releasing component, 50 driving component, 501 third end, 502 fourth end, 51 teeth groove, 510 second connecting shaft, 60 unlocking lever, 601 fifth end, 602 sixth end; 603 third connecting shaft, 61 catch tooth, 70 second reset component, 701 fourth connecting shaft, 8 positioning rod, 801 positioning slide groove, 90 anti-slip sleeve.

### DETAILED DESCRIPTION OF THE EMBODIMENTS

The technical solutions of the embodiments of the present disclosure will be clearly and completely described in conjunction with the accompanying drawings. It should be noted that the described embodiments are only part of the embodiments of the present disclosure, and not all of them. Based on the embodiments in the present disclosure, all other embodiments obtained by those of ordinary skill in the art without creative efforts fall within the scope of protection of the present disclosure.

The terms “first,” “second,” and so on, used in the specification, claims, and drawings, are only for the purpose of distinguishing different components, and not to imply any particular order. Additionally, the terms “include” and “have,” as well as any variations thereof, are intended to cover non-exclusive inclusions.

It should be noted that when a component is referred to as “fixed to” another component, it may be directly on that component or there may also be an intermediate component. When a component is referred to as “connected to” another component, it may be directly connected or connected via an intermediate component. When a component is “disposed on” another component, it may be disposed directly on it or via an intermediate structure.

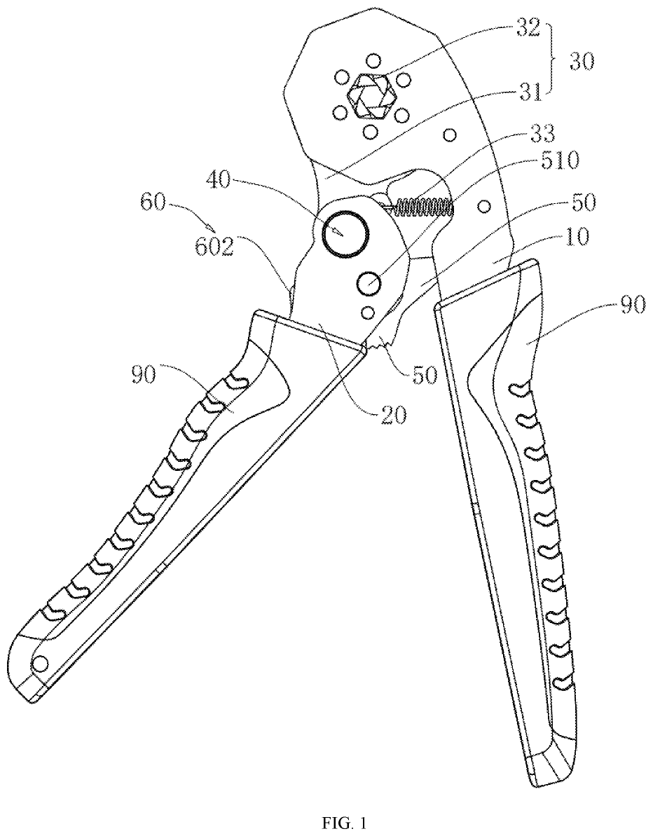

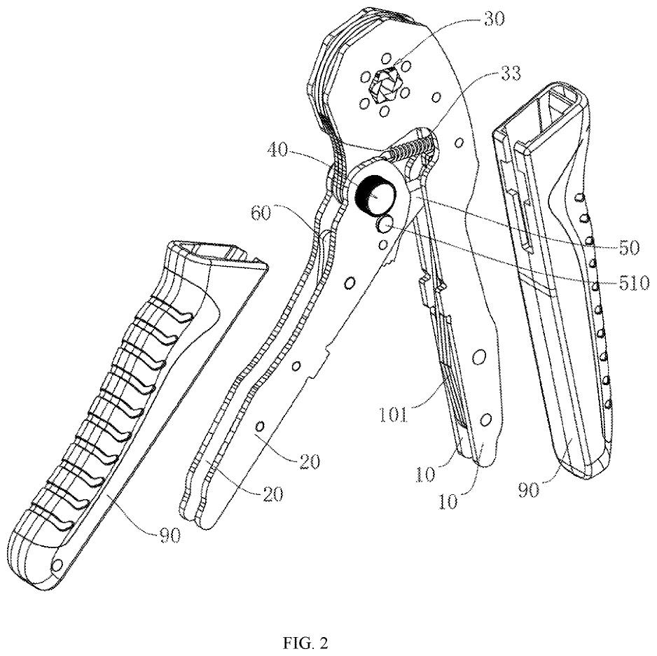

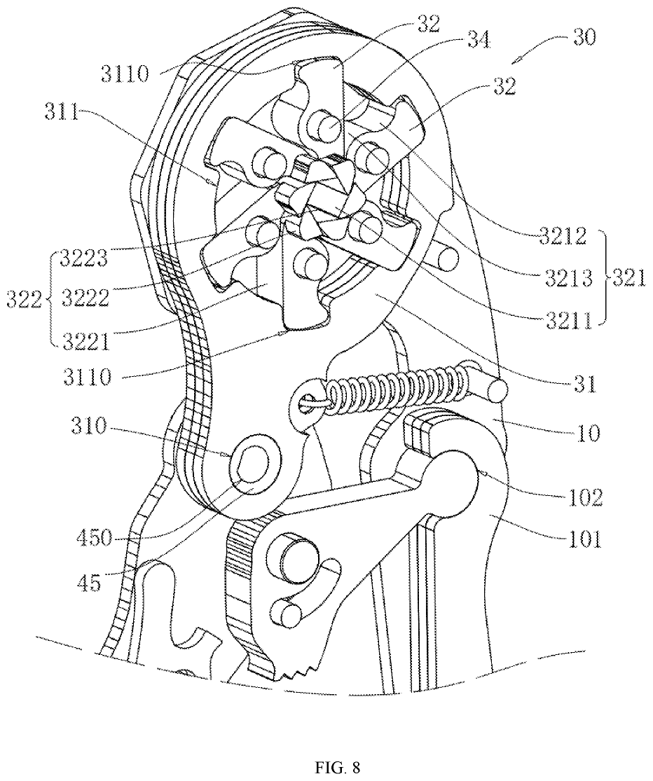

Referring to FIGS. 1-8, an embodiment of the present disclosure provides a crimping pliers 100, which includes a fixed handle 10, an active handle 20, a jaw 30, and an adjusting component 40. The fixed handle 10 and the active handle 20 are arranged facing each other. One end of the jaw 30 is rotatably connected to the fixed handle 10, while another end is positioned within the active handle 20. As shown in FIG. 2, both the fixed handle 10 and the active handle 20 are wrapped with anti-slip sleeves 90 for ease of gripping by the user.

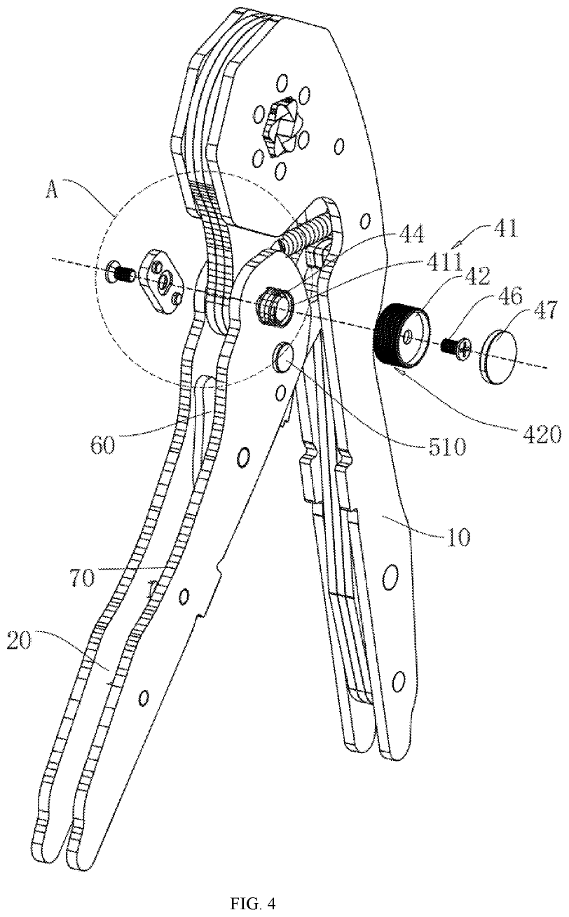

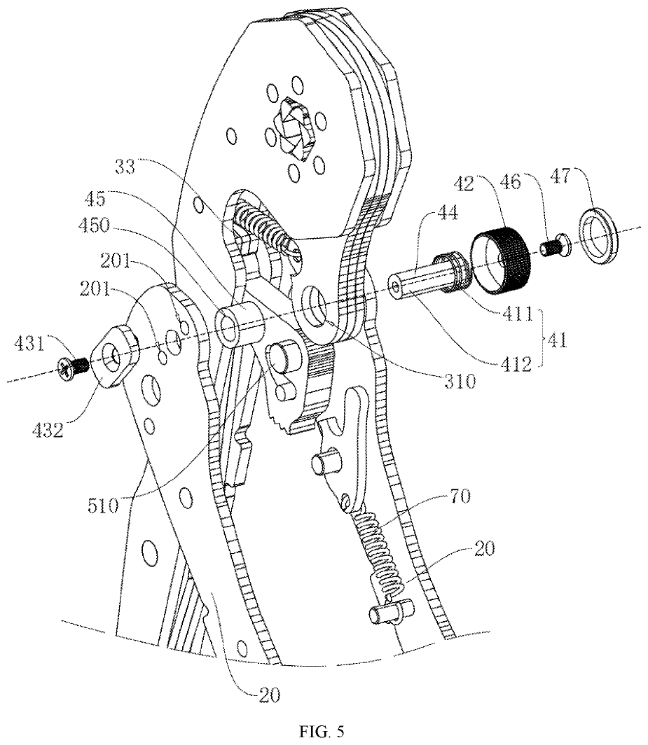

As illustrated in FIGS. 4-5, the adjusting component 40 includes an eccentric shaft 41, a knob 42, a limiting component 43, and a first reset component 44. The eccentric shaft 41 passes through both the jaw 30 and the active handle 20. It is rotatably connected to the active handle 20 and engaged with the jaw 30. When the eccentric shaft 41 rotates, it drives the jaw 30 to rotate relative to the fixed handle 10. Specifically, rotating the eccentric shaft 41 in a preset direction enlarges the opening of the jaw, while rotating it in the opposite direction narrows it. In other words, the crimping pliers 100 can adapt to wires of different diameters.

The knob 42 is fixed to a first end 411 of the eccentric shaft 41. The limiting component 43 is mounted to the second end 412 of the eccentric shaft 41, with the knob 42 and the limiting component 43 positioned on opposite sides of the active handle 20. The first reset component 44 is located between the knob 42 and the active handle 20, contacting both. More specifically, the eccentric shaft 41 passes through the first reset component 44.

Referring to FIGS. 4-6, the first reset component 44 can be a spring or an elastic sleeve. When the first reset component 44 in a first compressed state, a gap exists between the knob 42 and the active handle 20—this is a travel range for pressing the knob 42.

In this state, the limiting component 43 is fixed relative to the active handle 20. When pressed, the first reset component 44 enters a second compressed state, causing the limiting component 43 to disengage from the active handle 20. At this point, rotating the eccentric shaft 41 can drive the jaw 30 to rotate.

In the present embodiment, through the cooperation of the eccentric shaft 41, the knob 42, the limiting component 43, the first reset component 44, and the jaw 30, pressing the knob 42 separates the limiting component 43 from the active handle 20, allowing the user to rotate the eccentric shaft 41 to adjust the opening size of the jaw. This adjustment does not require additional tools, significantly improving ease of use.

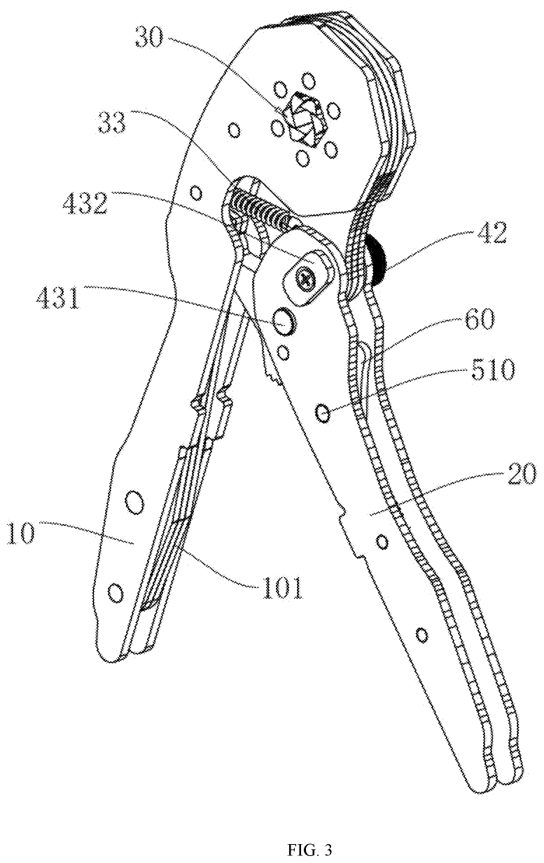

In some embodiments (see FIG. 3, and 5-6), the limiting component 43 includes a limiting base 432 and a limiting protrusion 430. The limiting base 432 is fixed to the second end 412 of the eccentric shaft via a first connecting portion 431. The limiting protrusion 430 is located on an end surface the limiting base 432, while the active handle 20 includes a limiting hole 201 for receiving the limiting protrusion 430. Alternatively, the limiting protrusion 430 is located on a fracture surface the limiting base 432, and the limiting base 432 is defined with the limiting hole 201 for embedding the limiting protrusion 430.

In this embodiment, the limiting protrusion 430 is integrally formed on the end surface of limiting base 432 facing the active handle 20. The active handle 20 is defined with a limiting hole 201. into which the protrusion 430 fits When the first reset component 44 is in the first compressed state, the limiting hole 201 is used to embed the limiting protrusion 430, thereby achieving relative fixation.

In some embodiments, the limiting protrusion 430 is provided on the limiting base 432, and the limiting hole 201 is defined on the active handle 20. There are at least two limiting protrusions 430 and at least two limiting holes 201, the at least two limiting protrusions 430 are arranged circumferentially along a rotational axis of the eccentric shaft 41. In this embodiment, there are two limit protrusions 430 and two limiting holes 201, the two limit protrusions 430 are corresponded to two limiting holes 201. The positions of the two limiting holes 201 and two limit protrusions 430 are designed to ensure strength within a smaller size range, effectively preventing issues such as hole cracking.

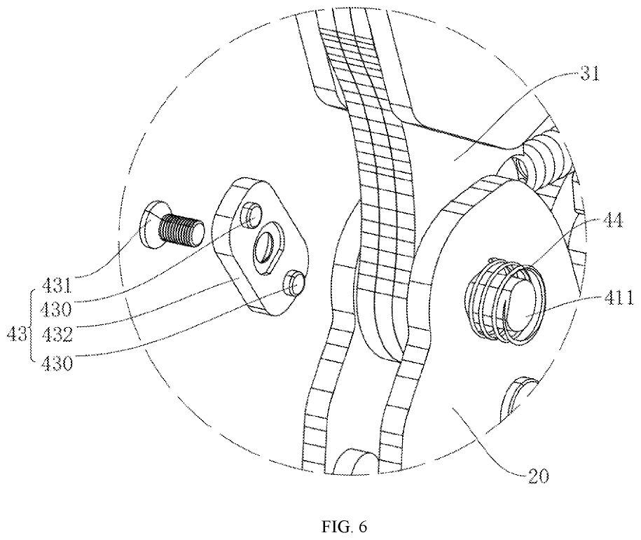

Referring to FIGS. 5 and 6, in some embodiments, the end of the jaw 30 near the active handle 20 includes a mounting hole 310. The adjusting component 40 further includes an eccentric wheel 45 fixed within the mounting hole 310, with a connecting hole 450 with a flattened position through which the eccentric shaft 41 is closely fitted. The eccentric wheel 45 supports the eccentric shaft 41 and facilitates component replacement due to wear, while being compact and cost-effective.

Additionally, a side of knob 42 is provided with a surrounding anti-slip pattern 421, which enhance friction and reduce slippage during rotation. It should be understand, a plurality of the surrounding anti-slip pattern 421 may be provided.

In some embodiments (FIGS. 5 and 6), the first connecting portion 431 is threaded into the eccentric shaft 41 via a threaded hole at a top of the second end. The adjusting component 40 also includes a second connecting portion 46 and a protective cap 47. The second connecting portion 46 passes through the knob 42 and threads into the top of the first end of the eccentric shaft 41, near the first reset component 44. It is also threaded to the knob 42, achieving a fixed connection.

The protective cap 47 is attached to the side of the knob 42 opposite the first reset component 44 via screwing or snapping. In this embodiment, the protective cap 47 fits into a mounting groove at that end of the knob. The screw-type connections between the limiting component 43 and knob 42 facilitate disassembly and maintenance. The protective cap 47 helps enhance the protection of the second connecting portion 46.

Referring to FIGS. 1 to 3, 5, and 8, in some embodiments, the jaw 30 includes an adjusting body 31, jaw tooth 32, and a third reset component 33. The jaw tooth 32 are provided in multiple pieces, with six jaw tooth 32 shown in the figure. The crimping pliers 100 also includes multiple first connecting shafts 34. The eccentric shaft 41 passes through the adjusting body 31. The end of the adjusting body 31, far from the eccentric shaft 41, is positioned within the fixed handle 10 and is provided with an accommodating through hole 311. An inner surface of the accommodating through hole 311 has multiple slots 3110 arranged in a ring shape, with six slots 3110 shown in the figure. The end of each jaw tooth 32 is placed in one of the slots 3110. Observing in the direction of arrangement of the slots 3110, each of the jaw tooth 32 includes a first surface 321 and a second surface 322, which are oppositely arranged. The first surface 321, away from the slot 3110, has a first plane 3211 inclined toward the second surface 322. The second surface 322 includes a second plane 3221, a third plane 3222, and a fourth plane 3223 arranged in sequence. The second plane 3221, the third plane 3222, and the fourth plane 3223 are obtusely angled, with the obtuse angle opposite to the first plane 3211. The fourth plane 3223 is adjacent to the first plane 3211. When adjusting the opening size of the jaw, the fourth plane 3223 slides along the first plane 3211 of an adjacent jaw tooth 32 of the jaw teeth. Each first connecting shaft 34 passes through one of the jaw teeth 32 in the normal direction of the accommodating through hole 311 and is mounted inside the fixed handle 10.

An example includes providing two opposing installation through holes in the fixed handle 10, so that a protruding end of the first connecting shaft 34 can be fixed in the installation through holes to be mounted on the fixed handle 10, with the jaw tooth 32 rotatable around the first connecting shaft 34. The ring-shaped arrangement of the jaw tooth 32 helps provide multi-directional compressive force, improving the stability of the crimping operation. The design of the jaw tooth 32 helps facilitate increasing the number of jaw tooth and enhances the stability of adjustments of the opening size of the jaw.

In this embodiment, the third reset component 33 is a tension spring. One end of the third reset component 33 is hooked to a position near the adjusting component 40 on the adjusting body 31, while the other end is hooked to an upper end of the fixed handle 10. This reset component 33 is used to keep the jaw 30 in the open state. In other words, when the active handle 20 and the fixed handle 10 are in a clamped state, the third reset component 33 is in a stretched state. Upon release, the third reset component 33 drives a lower end of the adjusting body 31 to move towards the fixed handle 10.

During specific operations, the adjusting body 31 rotates and drives the jaw tooth 32 to rotate around the first connecting shaft 34. The fourth plane 3223 of the jaw tooth slides away from the slot 3110, reducing the opening size of the jaw. Conversely, if moved in the opposite direction, the opening size of the jaw increases.

In some embodiments, when observed along a direction of the first plane 3211 towards the slot 3110, the first surface 321 further includes a concave surface 3212, a convex surface 3213, a concave surface 3212, and a convex surface 3213, which are arranged in sequence. The convex surface 3213 at the end is placed in the slot 3110, with the first connecting shaft 34 positioned at the other convex surface 3213. The projections of the concave surfaces 3212 and convex surfaces 3213 lie within the second plane 3221. This structure of the jaw tooth 32 ensures strength while maximizing the rotation angle of the adjustable range of the opening of the jaw.

In other embodiments, the jaw 30 may be hinged to the fixed handle 10, allowing relative opening and closing of the jaw 30 and fixed handle 10 to adjust the opening size of the jaw.

In some embodiments, as shown in FIG. 2, the crimping pliers 100 also includes a driving component 50, an unlocking lever 60, and a second reset component 70. The driving component 50 is positioned on the side of the jaw 30, near the eccentric shaft 41. The driving component 50 has a third end 501 and a fourth end 502. The third end 501 is rotatably connected within the fixed handle 10, and the fourth end 502 is rotatably connected within the active handle 20. The third end 501 is provided with multiple continuous teeth grooves 51, with three teeth grooves 51 shown.

The unlocking lever 60 includes a fifth end 601 and a sixth end 602. The fifth end 601 is rotatably connected within the active handle 20, while the sixth end 602 is exposed outside the active handle 20. The fifth end 601 is provided with a catch tooth 61 that can engage with the teeth grooves 51.

The second reset component 70 is a tension spring. One end of the tension spring is rotatably connected within the active handle 20, and the other end is rotatably connected to the fifth end 601. It is used to reset the unlocking lever 60 when the active handle 20 and fixed handle 10 are compressed to their maximum position.

More specifically, the unlocking lever 60 is inclined upward away from the fixed handle 10. In other embodiments, the unlocking lever 60 may also be configured to incline downward away from the fixed handle 10, facilitating single-handed operation for the user.

In some embodiments, the crimping pliers 100 includes a positioning rod 8 fixed inside the active handle 20. The driving component 50 is provided with a positioning sliding slot 801 that allows the positioning rod 8 to slide within it. A center axis of the positioning sliding slot 801 coincides with the rotational axis of the driving component 50 on the active handle 20.

In this embodiment, the side of the third end 501 is a circular surface, making it easier for the user to pull it. A connecting base 101 is fixed inside the fixed handle 10. One side of the connecting base 101 has a limiting slot 102, through which the third end 501 can be partially embedded to limit its movement.

The crimping pliers 100 also includes a second connecting shaft 510, a third connecting shaft 603, and a fourth connecting shaft 701. These shafts are installed within the active handle 20. The second connecting shaft 510 passes through an end of the driving component 50 that has the teeth grooves 51. The third connecting shaft 603 passes through the unlocking lever 60, allowing the unlocking lever 60 to rotate around it. The fourth connecting shaft 701 passes through the second reset component 70, away from the unlocking lever 60.

An example is to set two opposing installation through holes for the second connecting shaft 510, the third connecting shaft 603 and the fourth connecting shaft corresponding to the active handle 20, allowing each connecting shaft to be installed in the active handle 20. The installation hole for the third connecting shaft 603 has a diameter larger than that of the shaft, providing a clearance for movement.

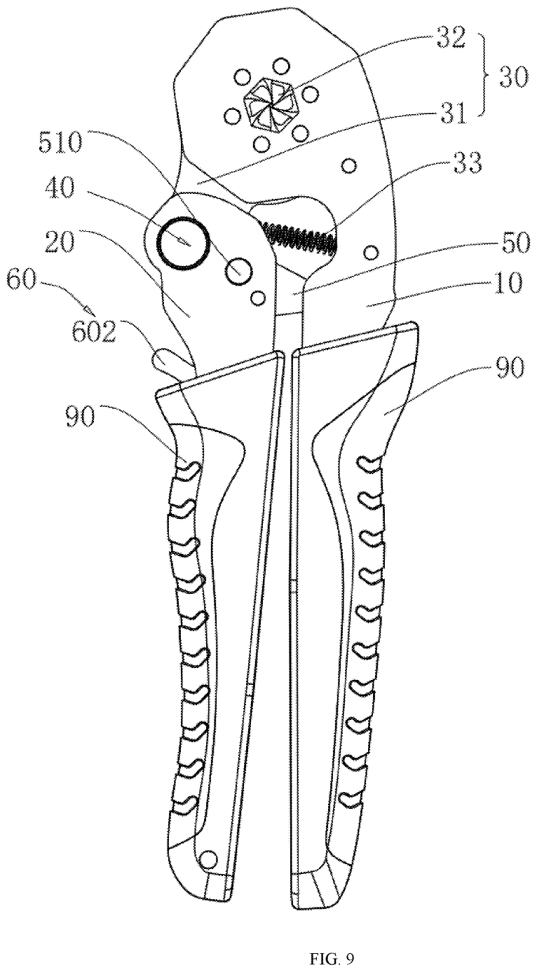

In some embodiments, as shown in FIG. 9, during the crimping operation, the sixth end 602 of the unlocking lever 60 rotates around the third connecting shaft 603, exposing most of it outside the active handle 20, making it easy for the user to directly unlock it with their thumb or finger. After the active handle 20 and fixed handle 10 are reset, as shown in FIG. 1, the sixth end 602 of the unlocking lever 60 is inside the active handle 20, preventing accidental activation, reducing unwanted loosening or air compression, and making the crimping pliers 100 more compact and easy to store and carry.

For ease of understanding, the following describes some operational methods of the crimping pliers 100.

In specific operation, you can press the knob 42 towards the direction close to the active handle 20, compressing the first reset component 44, which disengages the fixed relationship between the limiting component 43 and the active handle 20. Then, according to the actual needs, rotate the knob 42 along the preset direction to rotate the eccentric shaft 41, thereby driving the jaw 30 to rotate and adjusting the opening of jaw to the desired size. After the adjustment, release the knob 42 and reset the first reset component 44 to drive the limiting component 43, restoring the fixed relationship between the active handle 20 and the limiting component 43. At this point, you can press the active handle 20 towards the fixed handle 10, causing the active handle 20 to drive the jaw 30 to rotate and reduce the opening size of the jaw to complete the wire crimping.

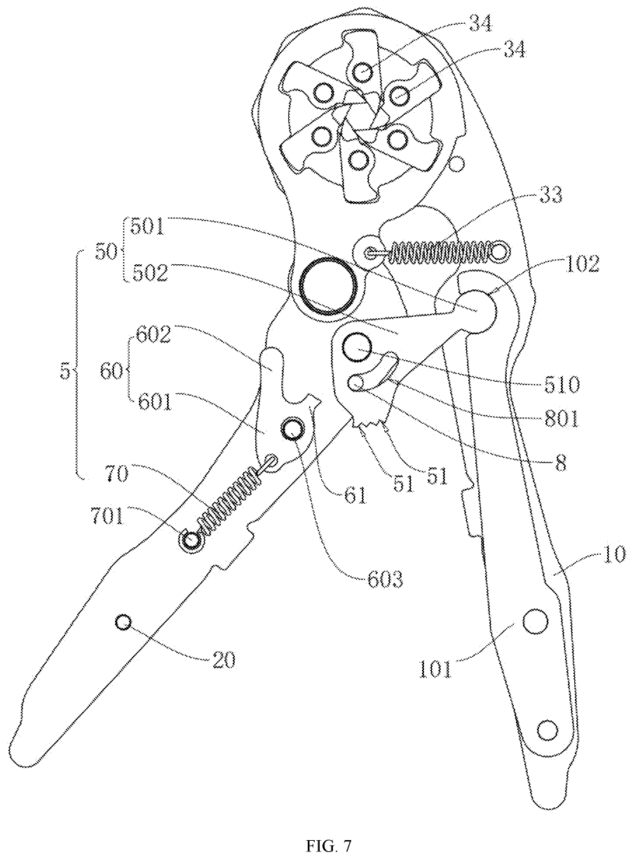

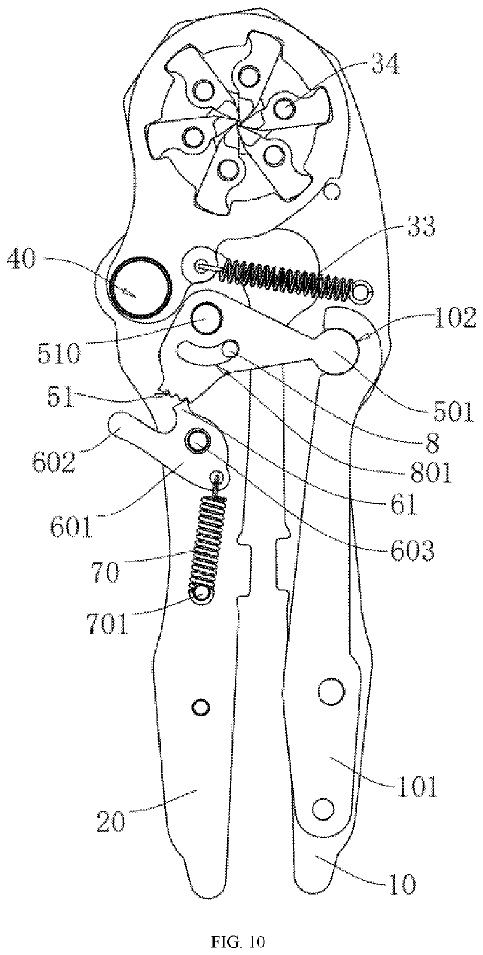

Referring to FIGS. 7 to 10, when the user needs to crimp terminals, the active handle 20 and the fixed handle 10 are pivoted close together. The third end 501 rotates relative to the fixed handle 10, causing the fourth end 502 to rotate clockwise around the third end 501, and the catch tooth 61 engages with the teeth grooves 51 and moves. At this point, the opening of the jaw 30 gradually narrows to crimp the terminal. When the active handle 20 and the fixed handle 10 pivot together until the jaw of the jaw 30 is fully closed, the active handle 20 and fixed handle 10 are compressed to their final position. At this stage, the catch tooth 61 will engage with the last slot of the teeth grooves 51 (as shown in FIG. 10). After the user completes crimping, two methods are available to release the crimping state for the next terminal.

Method 1: continue pressing the active handle 20 and the fixed handle 10 towards each other. The active handle 20 will drive the unlocking lever 60 towards the fixed handle 10, causing the positioning rod 8 on the active handle 20 to press the driving component 50. This the driving component 50 and forces the connecting base 101 with the limiting slot 102 to elastically deform in the direction away from the active handle 20. This creates space for the catch tooth 61 to disengage from the teeth grooves 51. Once the catch tooth 61 is disengaged from the teeth grooves 51, the elastic force from the second reset component 70 will reset the unlocking lever 60, opening the active handle 20 and fixed handle 10.

Method 2: the user can pull the exposed sixth end 602 of the unlocking lever 60, causing the catch tooth 61 to disengage from the teeth grooves 51. The elastic force from the second reset component 70 will then reset the unlocking lever 60, opening the active handle 20 and fixed handle 10.

Both operation methods in the present disclosure provide the user with a quick way to open the active handle 20 relative to the fixed handle 10, enabling continuous crimping operations.

It is important to emphasize that the distance between the active handle 20 and the fixed handle 10 is very small. Existing unlocking levers 60 are usually positioned between the active handle 20 and the fixed handle 10. When the jaw 30 becomes stuck due to an incorrect product model or specification, causing the active handle 20 and fixed handle 10 to jam, external tools are typically needed to unlock the teeth grooves 51 and the catch tooth 61.

In the present disclosure, the sixth end 602 of the unlocking lever 60 is exposed outside the active handle 20, i.e., the sixth end 602 is exposed in the direction away from the fixed handle 10. Compared to the unlocking lever 60 placed between the active handle 20 and the fixed handle 10, the crimping pliers 100 in the present disclosure allow the user to unlock it with one hand, making the operation easier and more straightforward.

The above embodiments are only preferred embodiments of the present disclosure and are not intended to limit the scope of protection. Any non-substantial modifications and replacements made by those skilled in the art based on the present disclosure fall within the scope of protection requested by the present disclosure.

What is claimed is:

1. A crimping pliers, comprising a fixed handle, an active handle, and a jaw, the crimping pliers further comprises an adjusting component for adjusting an opening size of the jaw, wherein the adjusting component comprising:
an eccentric shaft, which passes through both the active handle and the jaw, the eccentric shaft is configured to drive the jaw to rotate relative to the fixed handle;
a knob, fixedly connected to a first end of the eccentric shaft;
a limiting component, mounted at a second end of the eccentric shaft; and
a first reset component, positioned between the knob and the active handle;
wherein, when the first reset component is in a first compressed state, the limiting component is fixed relative to the active handle; and when the first reset component is compressed by the knob and in a second compressed state, the limiting component is separated from the active handle, allowing a rotation of the eccentric shaft to drive the jaw to rotate.

2. The crimping pliers according to claim 1, wherein the limiting component comprises:
a limiting seat, fixed to the second end;
a limiting protrusion, provided on the limiting seat or a surface of the active handle;
wherein the limiting seat or the active handle is defined with a limiting hole for the limiting protrusion to fit into, when the first reset component is in the first compressed state, the limiting protrusion fits into the limiting hole.

3. The crimping pliers according to claim 2, wherein the limiting protrusion is provided with at least two protrusions along a rotation axis of the eccentric shaft, and the limiting hole is provided with at least two limiting holes, one-to-one corresponding to the at least two limiting protrusions.

4. The crimping pliers according to claim 2, wherein the first reset component is a spring, with both ends of the spring abutting against the knob and the active handle;
wherein, when the spring is in the first compressed state, a gap is formed between the knob and the active handle.

5. The crimping pliers according to claim 2, wherein a side surface of the knob is provided with an anti-slip pattern.

6. The crimping pliers according to claim 2, wherein the jaw is defined with a mounting hole adjacent to the active handle, and the adjusting component further comprises an eccentric wheel fixed in the mounting hole, the eccentric wheel is defined with a connection hole with a flattened position, through which the eccentric shaft fits.

7. The crimping pliers according to claim 1, wherein the jaw comprises an adjusting body, jaw teeth, and a third reset component;
the adjusting body is passed through by the eccentric shaft, an end of the adjusting body away from the eccentric shaft is placed inside the fixed handle and defined with an accommodating through hole, an inner surface of the accommodating through hole is defined with multiple slots arranged in a ring; each of the jaw tooth has one end inserted into one of the multiple slots;
each of the jaw teeth comprise a first surface and a second surface; a first plane is provided on the first surface away from multiple slots, and the first plane is inclined toward the second surface; the second surface comprises a second plane, a third plane, and a fourth plane arranged in sequence; wherein the third plane and the second plane and the fourth plane are obtuse angles, the obtuse angles are opposite to the first plane; and the fourth plane is adjacent to the first plane;
when adjusting the opening size of the jaw, the fourth plane slides along the first plane of an adjacent jaw tooth of the jaw teeth.

8. The crimping pliers according to claim 7, wherein the crimping pliers further comprise multiple first connecting shafts, each of the multiple first connecting shafts passing through one jaw tooth of the jaw teeth along a normal direction of the accommodating through hole and installed inside the fixed handle.

9. A crimping pliers, wherein the crimping pliers comprise a fixed handle, an active handle, a jaw, an adjusting component, and a releasing component, the adjusting component is configured to adjust an opening size of the jaw, wherein the releasing component comprising:
a driving component, which comprises a third end and a fourth end; the third end is rotatably connected inside the fixed handle, the fourth end is rotatably connected inside the active handle, the fourth end is provides multiple teeth grooves, the multiple teeth grooves are arranged continuously;
an unlocking lever, which comprises a fifth end and a sixth end, the fifth end is rotatably connected inside the active handle, the sixth end is exposed on the outside of the active handle, the fifth end is provided with a catch tooth for engagement with the teeth grooves;
a second reset component, one end of the second reset component is connected to the active handle and another end of the second reset component is connected to the fifth end; when the active handle and the fixed handle are pressed to a final position, the second reset component is configured to reset the unlocking lever.

10. The crimping pliers according to claim 9, wherein the unlocking lever is inclined upwards towards a direction away from the fixed handle; or
the unlocking lever is set to incline downwards in the direction away from the fixed handle.

11. The crimping pliers according to claim 9, wherein an inside of the active handle is fixedly connected with a positioning rod, and the driving component is provided with a positioning slide groove for the positioning rod to slide, a center axis of the positioning slide groove is coincided with a rotation axis of the driving component on the active handle.

12. The crimping pliers according to claim 9, wherein a side of the third end is round, and a connecting seat is provided inside the fixed handle, a limiting groove is provided on the connecting seat, the limiting groove is configured for partially embedding the third end.

13. The crimping pliers according to claim 9, wherein the crimping pliers comprises a second connecting shaft, a third connecting shaft, and a fourth connecting shaft, which are all installed inside the active handle; wherein the second connecting shaft passes through the fourth end, the third connecting shaft passes through the unlocking lever, the unlocking lever is configured to rotate around the third connecting shaft; and the fourth connecting shaft passes through the second reset component at an end away from the unlocking lever.

14. The crimping pliers according to claim 9, wherein the second reset component is a tension spring, and the fourth connecting shaft passes through the second reset component at an end away from the unlocking lever, causing the tension spring to rotate and connect to the active handle, and another end of the tension spring is connected to the fifth end; when the active handle and the fixed handle are pressed to the final position, the tension spring is configured to reset the unlocking lever.

15. The crimping pliers according to claim 9, wherein when the active handle and the fixed handle are reset, the sixth end is hidden within the active handle.
